(19) United States
(12) Patent Application Publication
(10) Pub. No.: US 2006/0089286 A1
(43) Pub. Date: Apr. 27, 2006

(54) Detergent composition

(75) Inventors: Debojit Chakrabarty, Bangalore (IN); Amit Kumar Chaudhary, Bangalore (IN); Kamal Pramod Jha, Chicago, IL (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco, Inc. d/b/a UNILEVER

(21) Appl. No.: 11/255,377

(22) Filed: Oct. 21, 2005

(30) Foreign Application Priority Data
Oct. 21, 2004 (IN) 1132/MUM/2004

(51) Int. Cl. C11D 17/00

(52) U.S. Cl. 510/403; 510/499

(57) ABSTRACT

A liquid/gel cleaning composition comprising: (a) 0.5% to 50% of a mixture of an anionic surfactant and an amphoteric/zwitterionic surfactant; (b) 1% to 65% of a mixture of at least one polyol and a boron-containing compound; and (c) water.

The present invention relates to cleansing compositions in liquid/gel form. The invention more particularly relates to liquid cleansing compositions for personal washing applications that are thickened using ingredients that are inexpensive and widely available, while at the same time provide for in-use properties desired by the consumer.

Cleaning compositions in the liquid/gel state are preferred by many consumers for several applications including laundering of clothes, personal washing applications such as face-wash and body wash, and also for cleaning of hard surfaces like kitchen tiles and utensils. Depending on the specific application, several formulations have been proposed in the prior art.

In addition to the essential requirement that the formulation provides for good cleaning, a composition that has a sufficient thickness is preferred by consumers. Thickened liquid cleaning compositions give the consumer the perception of strong cleaning action. Importantly, the higher viscosity enables easy dispensing from the packaging without run-offs, leakages and other issues that the consumer perceives as negative attributes.

Liquid cleaning compositions have previously been thickened by incorporating higher levels of surfactant actives, which may for example be soap or non-soap actives. Alternately the compositions have been structured using polymers. Such methods of providing thickness to liquid cleaning compositions require the use of expensive raw materials like polymers and additional surfactants, which increases the cost of the formulation.

The present inventors have found that, surprisingly, a composition comprising a specific combination of two types of surfactants, viz. that of the anionic type and that of the amphoteric/zwitterionic type, can be structured using a mixture of a boron-containing compound and a polyol. However such behaviour is not observed when only one of these surfactants is present, or a combination of any other type of surfactant is present.

U.S. Pat. No. 5,468,414 (P&G, 1995) describes a liquid detergent composition comprising a boric-polyol complex, an active proteolytic enzyme, a second enzyme selected from lipase, amylase, cellulase and mixtures thereof, a surfactant selected from anionic and non-ionic and mixtures thereof, and an alphahydroxyacid builder wherein the polyol is a vicinal polyol. The boric-polyql complex serves to increase the efficacy of the enzyme system, which ensures that the proteolytic enzyme does not adversely affect the function of the other enzymes. However, this publication does not teach the advantage of incorporating a boron-polyol complex to a surfactant system comprising an anionic and an amphoteric/zwitterionic surfactant, in order to induce structuring.

EP 0080223 (Unilever, 1982) describes an aqueous enzymatic liquid detergent composition comprising a detergent active material, an enzyme stabilising system comprising a mixture of (a) boric acid and an alkali metal borate, and (b) a polyol or a polyfunctional amino compound in specific amounts and ratios, characterised in that the enzyme stabilising system further comprises a reducing alkali metal salt. This publication also describes an improved enzyme stabilisation system, and does not teach the use of a boron-polyol complex to build structuring in the specific anionic-amphoteric/zwitterionic surfactant mixture.

It is thus an object of the present invention to be able to provide for a liquid/gel cleaning composition that can be thickened using materials that are readily available, are available at lower cost, and therefore are more economical to prepare.

It is another object of the present invention to be able to provide for a liquid/gel cleaning composition that in addition to being thickened, provides for the other desired consumer perceptible attributes such as feel, lather and mildness on use.

According to a first aspect of the present invention there is provided a liquid/gel cleaning composition comprising:
(a) 0.5% to 50% of a mixture of an anionic surfactant and an amphoteric/zwitterionic surfactant;
(b) 1% to 65% of a mixture of at least one polyol and a boron-containing compound; and
(c) water.

According to a preferred aspect, there is provided a liquid/gel cleaning composition comprising:
(a) 0.5% to 50% of a mixture of an anionic surfactant and an amphoteric/zwitterionic surfactant;
(b) 1% to 65% of a mixture of at least one polyol and a boron-containing compound;
(c) 0.1% to 20% of an anti-oxidant selected from the group consisting of reducing alkali metal salts having an oxygenated sulphur anion; and
(d) water.

It is particularly preferred that the polyol comprises of more than two hydroxyl groups.

Another aspect of the present invention provides for a process for the preparation of a liquid/gel cleaning composition comprising:
(a) 0.5% to 50% of a mixture of an anionic surfactant and an amphoteric/zwitterionic surfactant;
(b) 1% to 65% of a mixture of at least one polyol and a boron-contaning compound; and
(c) water;
   which process comprises the step of mixing an aqueous solution of the surfactants with a polyol and a boron-contaning compound.

The present invention provides for a liquid/gel cleaning composition that comprises a mix of surfactants. The mix of surfactants comprises one or more of anionic surfactants and one or more of amphoteric or zwitterionic surfactants. The mix of surfactants is thickened with a mix of a polyol and a boron-containing compound. Although the invention could be used to prepare a liquid/gel composition for any application e.g. laundry, hard-surface cleaning or personal cleaning, it is particularly preferred that it is used for personal washing purposes, e.g as a face wash or body wash.

The boron-polyol mixture is prepared by mixing a boron-contaning compound, such as borax or boric acid with a polyol preferably with more than two hydroxyl groups, selected preferably from glycerol, sorbitol, xylitol, mannitol, monosaccharides, disaccharides, or any other polyol with reactive hydroxyl or amino (electron donating) groups. The boron-contaning compound and the polyol is preferably mixed in a ratio of from 1:12 to 1:1, more preferably 1:5 to 1:2, more preferably 1:5 to 1: greater than 2. The total amount of this mixture is preferably in an amount in the range of 1% to 60%, more preferably 3% to 20%, even more preferably 5% to 15% by weight of the composition.

The surfactants used in the composition comprise one or more anionic and one or more amphoteric/zwitterionic surfactants. The surfactants are present in an amount in the range of 0.5% to 50%, more preferably 1% to 30%, further more preferably 3% to 20% by weight of the composition. The anionic surfactant is preferably present in an amount of 0.25% to 40%, more preferably 0.5% to 20% and further more preferably 2% to 15% by weight of the composition. The amphoteric/zwitterionic surfactant is preferably present in an amount in the range of 0.2% to 20%, more preferably 0.3% to 15%, further more preferably 0.5% to 10% by weight of the composition.

Preferred weight ratios of the anionic: (amphoteric/zwitterionic) surfactant in the composition are in the range of 160:1 to 1:3, more preferably in the range of 60:1 to 1:2.

The anionic surfactant may be soap or non-soap. The term soap denotes salts of carboxylic fatty acids. The soap may be derived from any of the triglycerides conventionally used in soap manufacture—consequently the carboxylate anions in the soap may typically contain from 8 to 22 carbon atoms. The term total fatty matter, usually abbreviated to TFM, is used to denote the percentage by weight of fatty acid and triglyceride residues present in soaps without taking into account the accompanying cations.

For soap having 18 carbon atoms, an accompanying sodium cation will generally amount to about 8% by weight. Other cations may be employed as desired, for example zinc, potassium, magnesium, alkyl ammonium and aluminium.

The soap may be obtained by saponifying a fat and/or a fatty acid. The fats or oils generally used in soap manufacture may be such as tallow, tallow stearines, palm oil, palm stearines, soya bean oil, fish oil, castor oil, rice bran oil, sunflower oil, coconut oil, babassu oil, palm kernel oil, and others. In the above process the fatty acids are derived from oils/fats selected from coconut, rice bran, groundnut, tallow, palm, palm kernel, cotton seed, soyabean, castor etc. The fatty acid soaps can also be synthetically prepared (e.g. by the oxidation of petroleum or by the hydrogenation of carbon monoxide by the Fischer-Tropsch process). Resin acids, such as those present in tall oil, may be used. Naphthenic acids are also suitable.

Tallow fatty acids can be derived from various animal sources and generally comprise about 1% to 8% myristic acid, about 21% to 32% palmitic acid, about 14% to 31% stearic acid, about 0 to 4% palmitoleic acid, about 36% to 50% oleic acid and about 0 to 5% linoleic acid. A typical distribution is 2.5% myristic acid, 29% palmitic acid, 23% stearic acid, 2% palmitoleic acid, 41.5% oleic acid, and 3% linoleic acid. Other similar mixtures, such as those from palm oil and those derived from various animal tallow and lard, are also included.

Coconut oil refers to fatty acid mixtures having an approximate carbon chain length distribution of 8% C₈, 7% C₁₀, 48% C₁₂, 17% C₁₄, 8% C₁₆, 2% C₁₈, 7% oleic and 2% linoleic acids (the first six fatty acids listed being saturated). Other sources having similar carbon chain length distributions, such as palm kernel oil and babassu kernel oil, are included within the term coconut oil.

A typical fatty acid blend consists of 5% to 30% coconut fatty acids and 70% to 95% fatty acids ex. hardened rice bran oil. Fatty acids derived from other suitable oils/fats such as groundnut, soybean, tallow, palm, palm kernel, etc. may also be used in other desired proportions.

A suitable class of anionic synthetic surfactants are water-soluble salts of organic sulphuric acid mono-esters and sulphonic acids having in the molecular structure a branched or straight chain alkyl group containing 8-22 C atoms or an alkylaryl group containing 6-20 C atoms in the alkyl part.

Examples of such anionic surfactants are water-soluble salts of:
long chain (i.e. 8-22 C atom) alcohol sulphates (hereinafter referred to as PAS), especially those obtained by sulphating the fatty alcohols produced from tallow or coconut oil or the synthetic alcohols derived from petroleum;
alkylbenzene-sulphonates, such as those in which the alkyl group contains from 6 to 20 carbon atoms;
secondary alkanesulphonates.

Also suitable are the salts of:
alkylglyceryl ether sulphates, especially of the ethers of fatty alcohols derived from tallow and coconut oil;
fatty acid monoglyceride sulphates;
sulphates of ethoxylated aliphatic alcohols containing 1-12 ethyleneoxy groups;
alkylphenol ethylenoxy-ether sulphates with from 1 to 8 ethyleneoxy units per molecule and in which the alkyl groups contain from 4 to 14 carbon atoms;
the reaction product of fatty acids esterified with isethionic acid and neutralised with alkali.

Suitable amphoteric surfactant compounds that can be employed are derivatives of aliphatic secondary and tertiary amines containing an alkyl group of 8 to 18 carbon atoms and an aliphatic radical substituted by an anionic water-solubilizing group, for instance sodium 3-dodecylamino-propionate, sodium 3-dodecylaminopropane sulphonate and sodium N-2-hydroxydodecyl-N-methyltaurate. Amphoteric surfactants especially preferred include alkyl betaines and alkyl amidopropylbetaines.

Suitable zwitterionic detergent-active compounds that can be employed are derivatives of aliphatic quaternary ammonium, sulphonium and phosphonium compounds having an aliphatic radical of from 8 to 18 carbon atoms and an aliphatic radical substituted by an anionic water-solubilising group, for instance 3-(N-N-dimethyl-N-hexadecylammonium) propane-1-sulphonate betaine, 3-(dodecylmethyl sulphonium) propane-1-sulphonate betaine and 3-(cetylmethylphosphonium) ethane sulphonate betaine.

Further examples of suitable surfactants are compounds commonly used as surface-active agents given in the well-known textbooks: “Surface Active Agents” Vol. 1, by Schwartz & Perry, Interscience 1949; “Surface Active Agents” Vol. 2 by Schwartz, Perry & Berch, Interscience 1958; the current edition of “McCutcheon's Emulsifiers and Detergents” published by Manufacturing Confectioners Company; “Tenside-Taschenbuch”, H. Stache, 2nd Edn., Carl Hauser Verlag, 1981.

Optionally, an anti-oxidant is included in the composition of the invention. The antioxidant, if included, is preferably selected from the group consisting of reducing alkali metal salts having an oxygenated sulphur anion. Preferred anti-oxidants include alkali sulphites, alkali bisulphites, alkali meta bisulphites and alkali metal thiosulphates with the preferred alkali metals being sodium and potassium. A particularly preferred antioxidant is sodium meta bisulphite. The anti-oxidant is preferably present in an amount of 0.1% to 20%, more preferably 0.2% to 10% by weight of the composition.

If the composition is formulated for personal wash, benefit agents e.g. humectants, moisturisers, emollients, sunscreens, or anti-ageing compounds may be incorporated. Examples of suitable humectants include polyols, glycerol, cetyl alcohol, carbopol, ethoxylated castor oil, paraffin oils, lanolin and its derivatives. Silicone compounds such as silicone surfactants like DC3225C (Dow Corning) and/or silicone emollients, silicone oil (DC-200 Ex-Dow Corning) may also be included. Suitable sunscreens include 4-tertiary butyl-4′-methoxy dibenzoylmethane (available under the trade name PARSOL 1789 from Givaudan) and/or 2-ethyl hexyl methoxy cinnamate (available under the trade name PARSOL MCX from Givaudan) or other UV-A and UV-B sun-screens. Water soluble glycols such as propylene glycol, ethylene glycol, or glycerol may also be employed, at levels up to 10%.

An inorganic particulate phase is not an essential ingredient of the formulation, but may be incorporated, especially for hard surface cleaning compositions and for cost effectiveness. Preferably, the particulate phase comprises a particulate structurant and/or abrasive, which is insoluble in water.

Other additives such as one or more water insoluble particulate materials such as polysaccharides, for example starch or modified starches or cellulose may be incorporated. Similarly enzymes and bleaches can be incorporated at levels from 0 to 5%. However in a highly preferred embodiment, the composition is free (e.g. contains less than about 0.001%) of enzymes.

Conventional minor additive ingredients preferably selected from enzymes, anti-redeposition agents, fluorescers, colour, preservatives and perfumes, also bleaches, bleach precursors, bleach stabilisers, sequestrants, soil release agents (usually polymers) and other polymers may optionally be incorporated up to 10 wt %, depending upon the desired end application.

Another aspect of the present invention provides for a process for the preparation of a liquid/gel cleaning composition of the invention, that comprises mixing an aqueous solution of the surfactants with the aqueous mixture of the polyol and the boron-contaning compound.

Alternately, the aqueous solution of the surfactants could be mixed with the polyol, following which the boron-containing compound is added. When the anti-oxidant is included in the composition, it is preferred that the anti-oxidant is mixed with the mixture of the polyol and the boron-containing compound before it is mixed with the surfactant solution. Although the mixing process could be done at any temperature at which the constituents are thermally stable, it is preferred that the mixing is carried out at a temperature in the range of 25 to 90° C., more preferably between 50 to 80° C.

The invention will now be demonstrated with the help of typical non-limiting examples of the invention, and also with the help of comparative results of compositions prepared outside the scope of the invention.

### EXAMPLES

The cleaning compositions were prepared using the following procedure.

The quantity of surfactants to be used were taken and mixed with 50% of the total water amount to be used, in a beaker. The mixture was heated to 70° C. in a water bath. In a separate beaker, the boron-containing compound and the polyol were mixed along with the rest of the water and heated to 70° C. When present, the anti-oxidant was added to the beaker containing the boron-containing compound and the polyol. The contents of the two beakers were then mixed together for about 15 minutes, and the mixture maintained at 70° C. The mixture was then cooled to 25° C., and any loss of water due to evaporation was appropriately compensated. The composition was then allowed to stand for 24 hours at 25° C. The viscosity of the composition was then measured using a DV II Brookfield Viscometer using spindle RV4 at 4 rpm.

The various compositions prepared with the selected surfactants are as per the invention are summarized in Table-1. Compositions as per the invention, which have been additionally structured using sodium meta bisulphate, are summarized along with relevant viscosity data in Table 2. The various compositions where the surfactant mix is a combination outside the scope of the invention, along with their viscosity data is represented and summarized in Table 3.

TABLE 1
Examples according to the invention

| | Surfactant | | Surfactant 2 | | Viscosity with | Viscosity with |
|---|---|---|---|---|---|---|
| Example | 1 - S1 | Wt % | S2 | Wt % | sorbitol (7%) | Borax (2.7%) and |
| No | Anionic | S1 | Amphoteric | S2 | alone, cps | sorbitol (7%), cps |
| 1 | SLES | 7.5 | CAPB | 2.5 | 115 | 2760 |
| 2 | AOS | 5.0 | CAPB | 5.0 | 200 | 35560 |
| 3 | AOS | 6.0 | CAPB | 4.0 | 160 | 13960 |
| 4 | AOS | 7.5 | CocoB | 2.5 | 40 | 1160 |
| 5 | LAS | 7.5 | CocoB | 2.5 | 520 | 2920 |
| 6 | SLES | 7.5 | CocoB | 2.5 | 240 | 13600 |
| 7 | SLS | 7.5 | CAPB | 2.5 | 120 | 40000 |

The legends used in Table 1 refer to the following;
SLES: Sodium Lauryl ethoxy sulphate
AOS: Alpha-olefin sulphonate
LAS: Linear alkyl benzene sulphonate
CAPB: Coco amido propyl betaine
CocoB: Coco betaine

TABLE 2
Examples according to the invention additionally with SMBS

| | | | | | Viscosity with | Viscosity with |
|---|---|---|---|---|---|---|
| | Surfactant | | Surfactant 2 | | Borax(2.7%) | Borax (2.7%), |
| Example | 1 - S1 | Wt % | S2 | Wt % | and sorbitol | sorbitol (7%) and |
| No | Anionic | S1 | Amphoteric | S2 | (7%), cps | SMBS (0.5%), cps |
| 8 | SLES | 7.5 | CAPB | 2.5 | 2760 | 12080 |
| 9 | LAS | 7.5 | CAPB | 2.5 | 2600 | 3360 |
| 10 | SLES | 7.5 | CocoB | 2.5 | 13600 | 18120 |

TABLE 3
Comparative Examples

| | | | | | Viscosity of | Viscosity of mix |
|---|---|---|---|---|---|---|
| | | | | | mix with | with Borax (2.7) |
| Example | Surfactant1 | Wt % | Surfactant2 | Wt % | sorbitol (7%) | and sorbitol (7%), |
| No | S1 | S1 | S2 | S2 | alone, cps | cps |
| | Anionic | | Anionic | | | |
| A | SLES | 7.5 | SLS | 2.5 | 160 | 40 |
| B | AOS | 5.0 | LAS | 5.0 | 40 | 80 |
| C | SLES | 5.0 | LAS | 5.0 | 40 | 160 |
| | Anionic | | Nonionic | | | |
| D | SLES | 7.5 | SMS | 2.5 | ps | ps |
| E | SLES | 7.5 | SMO | 2.5 | ps | ps |
| F | LAS | 7.5 | SMS | 2.5 | ps | ps |
| G | SLES | 7.5 | Triton | 2.5 | 40 | 160 |
| H | LAS | 7.5 | 7EO | 2.5 | 80 | 160 |
| | Anionic | | Cationic | | | |
| I | SLES | 7.5 | Arquad | 2.5 | 80 | 120 |
| | Nonionic | | Nonionic | | | |
| J | SMS | 7.5 | SMO | 2.5 | ps | ps |
| K | Triton-X-100 | 5.0 | SMS | 5.0 | ps | ps |
| | Nonionic | | Cationic | | | |
| L | 3EO | 7.5 | Arquad | 2.5 | 800 | 120 |
| M | 7EO | 7.5 | Arquad | 2.5 | 80 | 120 |
| | Nonionic | | Amphoteric | | | |
| N | SMS | 7.5 | CAPB | 2.5 | ps | ps |
| O | SMS | 7.5 | CocoB | 2.5 | ps | ps |
| | Cationic | | Amphoteric | | | |
| P | Arquad | 7.5 | CocoB | 2.5 | 80 | 120 |
| | Amphoteric | | Amphoteric | | | |
| Q | CAPB | 7.5 | CocoB | 2.5 | 160 | 40 |
| R | CAPB | 5.0 | CocoB | 5.0 | 160 | 40 |

The legends used in Table 3 refers to the following (in addition to those already listed under Table 1):
SLS: Sodium Lauryl sulphate
SMS: Sorbitan Mono Stearate
SMO: Sorbitan Mono Oleate
7EO: SLES with 7 ethoxylate units
3EO: SLES with 3 ethoxylate units
Arquad: Cetyltrimethyl ammonium chloride
Triton-X-100: [polyoxyethylene(10) isooctylphenyl ether]
ps: phase separation under ambient conditions.

The examples as shown in Table 1 demonstrate that only the selective surfactant combination within the scope of the invention provide for thickening of the liquid/gel cleaning composition, while other combinations of surfactants outside the scope of the invention (Table 3) do not provide the structuring benefit. Additionally, the use of an anti-oxidant further enhances the thickening benefit, as shown in Table 2.

1. A liquid/gel cleaning composition comprising:
(a) 0.5% to 50% of a mixture of an anionic surfactant and an amphoteric/zwitterionic surfactant;
(b) 1% to 65% of a mixture of at least one polyol and a boron-containing compound; and
(c) water.

2. The liquid/gel cleaning composition as claimed in claim 1 wherein the polyol comprises more than two hydroxyl groups.

3. The liquid/gel cleaning composition as claimed in claim 1 wherein the polyol is selected from glycerol, sorbitol, xylitol, mannitol, monosaccharides, and disaccharides.

4. The liquid/gel cleaning composition as claimed in claim 1 wherein the boron-containing compound is boric acid or borax.

5. The liquid/gel cleaning composition as claimed in claim 1 wherein the boron-containing compound and the polyol are present in the ratio of 1:12 to 1:1.

6. The liquid/gel cleaning composition as claimed in claim 5 wherein the ratio is in the range of 1:5 to 1:greater than 2.

7. The liquid/gel cleaning composition as claimed in claim 1 wherein the boron-containing compound and the polyol are present in the range of 3% to 20% by weight of the composition.

8. The liquid/gel cleaning composition as claimed in claim 7 wherein the amount of boron-containing compound and the polyol are present in an amount in the range of 5% to 15%.

9. The liquid/gel cleaning composition as claimed in claim 1 wherein the surfactant is present in an amount in the range of 1% to 30% by weight of the composition.

10. The liquid/gel cleaning composition as claimed in claim 1 wherein the anionic and the amphoteric/zwitterionic surfactant are present in amounts in a ratio in the range of 60:1 to 1:2.

11. The liquid/gel cleaning composition as claimed in claim 1 wherein the composition includes 0.1% to 20% of an anti-oxidant selected from reducing alkali metal salts having an oxygenated sulphur anion.

12. The liquid/gel cleaning composition as claimed in claim 11 wherein the anti-oxidant is sodium meta-bisulphite.

13. The liquid/gel cleaning composition as claimed in claim 1, wherein the composition is free of enzymes.

14. A process for the preparation of a liquid/gel cleaning composition comprising:
(a) 0.5% to 50% of a mixture of an anionic surfactant and an amphoteric/zwitterionic surfactant;
(b) 1% to 65% of a mixture of at least one polyol and a boron-containing compound; and
(c) water;
which process comprises the step of mixing an aqueous solution of the surfactants with a polyol and a boron-containing compound.
